(19) United States
(12) Patent Application Publication
(10) Pub. No.: US 2026/0067074 A1
(43) Pub. Date: Mar. 5, 2026

(54) DATA DISTRIBUTION SYSTEM, DATA DISTRIBUTION METHOD, AND DATA DISTRIBUTION PROGRAM

(71) Applicant: NEC Corporation, Tokyo (JP)

(72) Inventors: Nakul GHATE, Tokyo (JP); Hirofumi UEDA, Tokyo (JP); Daichi AOKI, Tokyo (JP)

(73) Assignee: NEC Corporation, Tokyo (JP)

(21) Appl. No.: 19/308,473

(22) Filed: Aug. 25, 2025

(30) Foreign Application Priority Data
Aug. 30, 2024 (JP) 2024-148373

(51) Int. Cl. H04L 9/08

(52) U.S. Cl. CPC H04L 9/0861

(57) ABSTRACT

A data distribution system that distributes an encrypted data from a transmitting device to a receiving device via a relay device with support by a key issuing device, wherein the key issuing device is configured to generate public parameters for ElGamal encryption and a secret key for attribute-based encryption, send the public parameters to the transmitting device and keep the secret key; and the transmitting device is configured to encrypt data by the public parameters, create a user defined policy for each data ID, attach the defined policy for the corresponding data ID to the encrypted data and send the encrypted data with the user defined policy to the relay device.

### TECHNICAL FIELD

### Reference to Related Application

The present disclosure is based upon and claims the benefit of the priority of Japanese patent application No. 2024-148373 filed on Aug. 30, 2024, the disclosure of which is incorporated herein in its entirety by reference thereto.

The present invention relates to a data distribution system, a data distribution method, and a data distribution program.

### BACKGROUND

Proxy re-encryption (PRE) is a method of public key cryptography in which a third party can convert a ciphertext that can be decrypted by a user A into another ciphertext that can be decrypted by a user B. A data distribution system that performs disclosure control using Attribute-based PRE is known. For example, Patent Literature (PTL) 1 discloses a data distribution system with Attribute-based PRE. In a distribution system with Attribute-based PRE, the Re-encryption key converts data into ciphertext that can be decrypted by specific attributes specifying an access policy.
[PTL 1] International Publication W02011/045723A1

### SUMMARY

The disclosures of the above prior art document shall be incorporated by reference into this document. The following analysis has been made by the inventors.

In the conventional distribution system with Attribute-based PRE, data owner generates and manage the Re-encryption key (see PTL 1 for example). The conventional distribution system with Attribute-based PRE has problem of not being suitable for users with large database, frequent sharing, IOT devices, and so on because Attribute-based PRE and revocation is computationally expensive. The workload cost becomes extremely high in lightweight IoT devices.

In view of the above problems, it is an object of the present invention to provide a data distribution system, a data distribution method, and a data distribution program that contribute to reduce the workload in a data transmitting device.

According to a first aspect of the present invention, there is provided a data distribution system that distributes an encrypted data from a transmitting device to a receiving device via a relay device with support by a key issuing device, wherein the key issuing device is configured to generate public parameters for ElGamal encryption and a secret key for attribute-based encryption, send the public parameters to the transmitting device and keep the secret key;
the transmitting device is configured to encrypt data by the public parameters, create a user defined policy for each data ID, attach the defined policy for the corresponding data ID to the encrypted data and send the encrypted data with the user defined policy to the relay device; the relay device is configured to separate the user defined policy from the encrypted data and provide the user defined policy to the key issuing device;
the key issuing device is configured to generate a re-encryption key with a cipher by using the secret key and the user defined policy for the corresponding data ID and a decryption key to decrypt the re-encrypted data by the receiving device that satisfies the user defined policy, send the re-encryption key with the cipher to the relay device and send the decryption key to the receiving device that satisfies the user defined policy;
the relay device is configured to re-encrypt the encrypted data of data ID by using the re-encryption key with the cipher and send the re-encrypted data to the receiving device; and the receiving device is configured to decrypt the re-encrypted data by using the decryption key.

According to a second aspect of the present invention, there is provided a data distribution method to distribute an encrypted data from a transmitting device to a receiving device via a relay device with support by a key issuing device, the method including:
generating, by the key issuing device, public parameters for ElGamal encryption and a secret key for attribute-based encryption, sending the public key to the transmitting device and keeping the secret key; encrypting, by the transmitting device, data by the public parameters, creates a user defined policy for each data ID, attaching the user defined policy for the corresponding data ID to the encrypted data and sending the encrypted data with the user defined policy to the relay device; separating, by the relay device, the user defined policy from the encrypted data and providing the user defined policy to the key issuing device;
generating, by the key issuing device, a re-encryption key with a cipher by using the secret key and the user defined policy for the corresponding data ID and a decryption key to decrypt the re-encrypted data by the receiving device that satisfies the user defined policy, sending the re-encryption key with the cipher to the relay device and sending the decryption key to the receiving device that satisfies the user defined policy;
re-encrypting, by the relay device, the encrypted data of data ID by using the re-encryption key with the cipher and sends the re-encrypted data to the receiving device; and decrypting, by the receiving device, the re-encrypted data by using the decryption key.

According to a third aspect of the present invention, there is provided a data distribution program to distribute an encrypted data from a transmitting device to a receiving device via a relay device with support by a key issuing device, the program including:
causing the key issuing device to generate public parameters for ElGamal encryption and a secret key for attribute-based encryption, send the public parameters to the transmitting device and keep the secret key;
causing the transmitting device to encrypt data by the public parameters, create a user defined policy for each data ID, attach the defined policy for the corresponding data ID to the encrypted data and send the encrypted data with the user defined policy to the relay device; causing the relay device to separate the user defined policy from the encrypted data and provide the user defined policy to the key issuing device;
causing the key issuing device to generate a re-encryption key with a cipher by using the secret key and the user defined policy for the corresponding data ID and a decryption key to decrypt the re-encrypted data by the receiving device that satisfies the user defined policy, send the re-encryption key with the cipher to the relay device and send the decryption key to the receiving device that satisfies the user defined policy;
causing the relay device to re-encrypt the encrypted data of data ID by using the re-encryption key with the cipher and send the re-encrypted data to the receiving device; and causing the receiving device to decrypt the re-encrypted data by using the decryption key.

According to each aspect of the present invention, there can be provided a data distribution system, a data distribution method, and a data distribution program that contribute to reduce the workload in a data transmitting device.

### BRIEF DESCRIPTION OF DRAWINGS

FIG. 1 is a schematic diagram for illustrating a data distribution system.

FIG. 2 illustrates a first step of a data distribution process.

FIG. 3 illustrates a second step of a data distribution process.

FIG. 4 illustrates a third step of a data distribution process.

FIG. 5 illustrates a fourth step of a data distribution process.

FIG. 6 illustrates a fifth and sixth step of a data distribution process.

FIG. 7 illustrates a seventh and eighth step of a data distribution process.

FIG. 8 is a system diagram of a data distribution method in encryption and re-encryption phase.

FIG. 9 is a system diagram of a data distribution method in decryption phase.

FIG. 10 illustrates a process in encryption phase.

FIG. 11 illustrates a process in re-key generation phase.

FIG. 12 illustrates a process in re-encryption phase.

FIG. 13 illustrates a process in decryption phase.

FIG. 14 is a flow chart of a data distribution method.

FIG. 15 is a drawing illustrating an example of a hardware configuration of a transmitting device, a receiving device, a relay device and a key issuing device.

### PREFERRED MODES

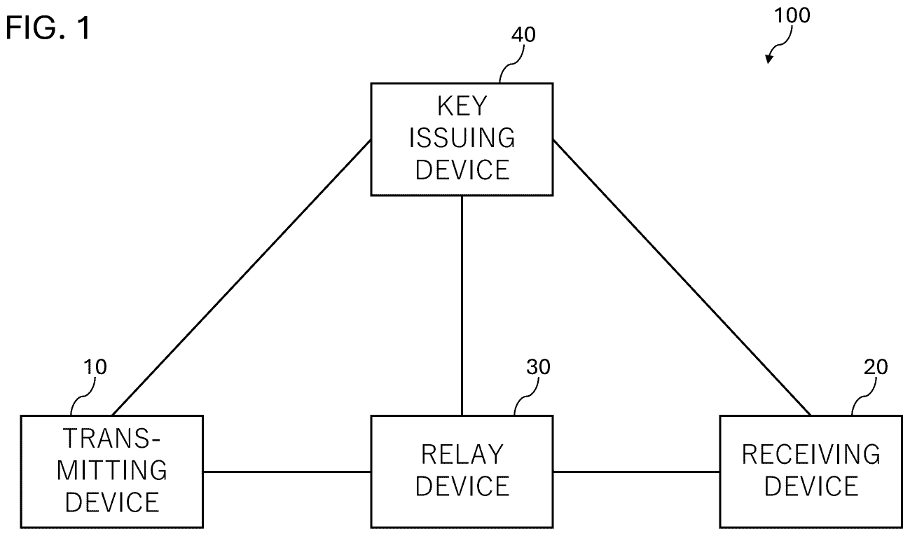

FIG. 1 is a schematic diagram for illustrating a data distribution system. As shown in FIG. 1, the data distribution system 100 comprises a transmitting device 10, a receiving device 20, a relay device 30, and a key issuing device 40. For example, the transmitting device 10 is operated by a data provider, the receiving device 20 is operated by a data user, the relay device 30 is operated by an info bank, and the key issuing device 40 is operated by a trusted organism. The data distribution system 100 distributes an encrypted data from the transmitting device 10 to the receiving device 20 via the relay device 30 with support by the key issuing device 40.

The key issuing device 40 is configured to output a pair of a public key and a secret key, send the public key to the transmitting device and keep the secret key. The public key is an encryption key to encrypt data. The secret key is decryption key to decrypt the data encrypted by the public key.

The transmitting device 10 is configured to encrypt data by the public key, create a user defined policy for each data ID, attach the defined policy for the corresponding data ID to the encrypted data and send the encrypted data with a user defined policy to the relay device 30. The user defined policy defines a permission to decrypt the encrypted data. For example, the permission is defined by attributes to allow for decrypting the encrypted data.

The relay device 30 is configured to separate the user defined policy from the encrypted data and provide the user defined policy to the key issuing device 40. The encrypted data contains the user defined policy and the relay device 30 separates the user defined policy from the encrypted data.

The key issuing device 40 is configured to generate a re-encryption key using the secret key and the user defined policy for the corresponding data ID and a decryption key to decrypt the re-encrypted data by the receiving device 20 that satisfies the user defined policy, send the re-encryption key to the relay device 30 and send the decryption key to the receiving device 20 that satisfies the user defined policy. The re-encryption key converts the encrypted data that can be decrypted by the secret key into another encrypted data that can be decrypted by the decryption key for the user defined policy. The key issuing device generates the re-encryption key using the secret key and the user defined policy.

The relay device 30 is configured to re-encrypt the encrypted data of data ID by using the re-encryption key and send the re-encrypted data to the receiving device 20. The re-encrypted data can be decrypted only by the decryption key for the user defined policy.

The receiving device 20 is configured to decrypt the re-encrypted data by using the decryption key. The key issuing device 40 sends the decryption key to the receiving device 20 that satisfies the user defined policy. The re-encrypted data can be decrypted only if the receiving device 20 satisfies the user defined policy.

As described above, in the conventional data distribution system with Attribute-based PRE, data owner (a data transmitting device) generates the Re-encryption key and Attribute-based PRE is computationally expensive. In contrast, the transmitting device 10 in the above example embodiment does not generates the Re-encryption key. Therefore, the data distribution system in the above example embodiment reduces the workload in a data transmitting device 10.

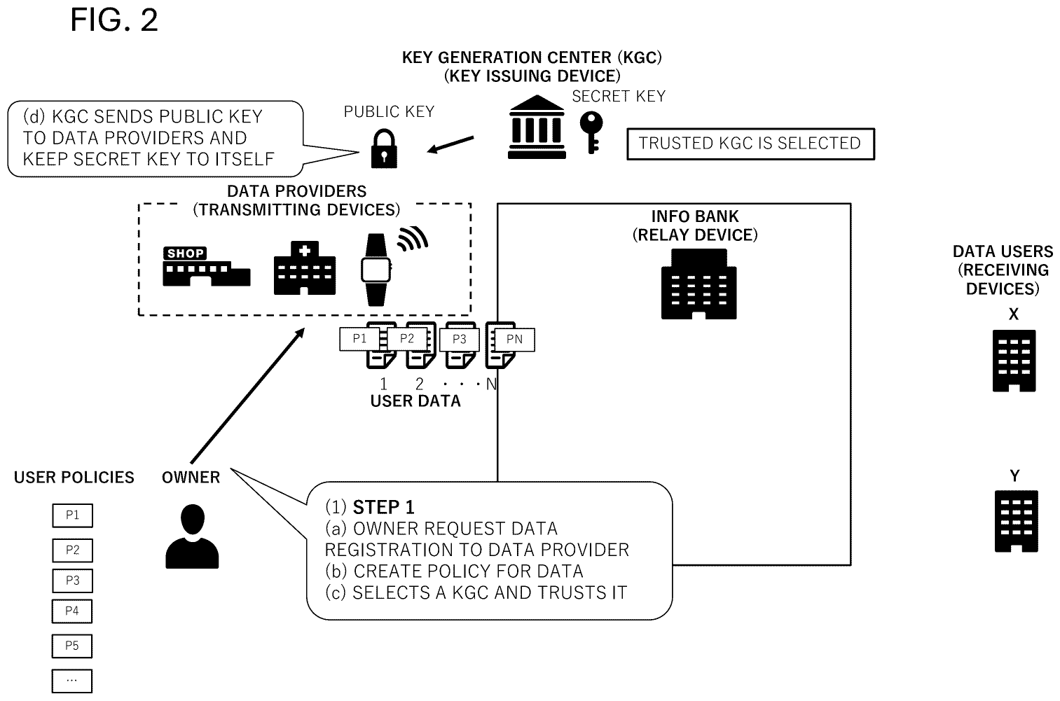

FIG. 2 illustrates a first step of a data distribution process. As described in FIG. 2, (a) the data owner request data 1, 2, . . . , N registration to data provider (transmitting device), (b) create policy for the data, and (c) select a key generation center (KGC) (key issuing device) and trust it. On the other hand, (d) the key generation center (KGC) (key issuing device) sends public key to data providers (transmitting devices) and keep secret key to itself.

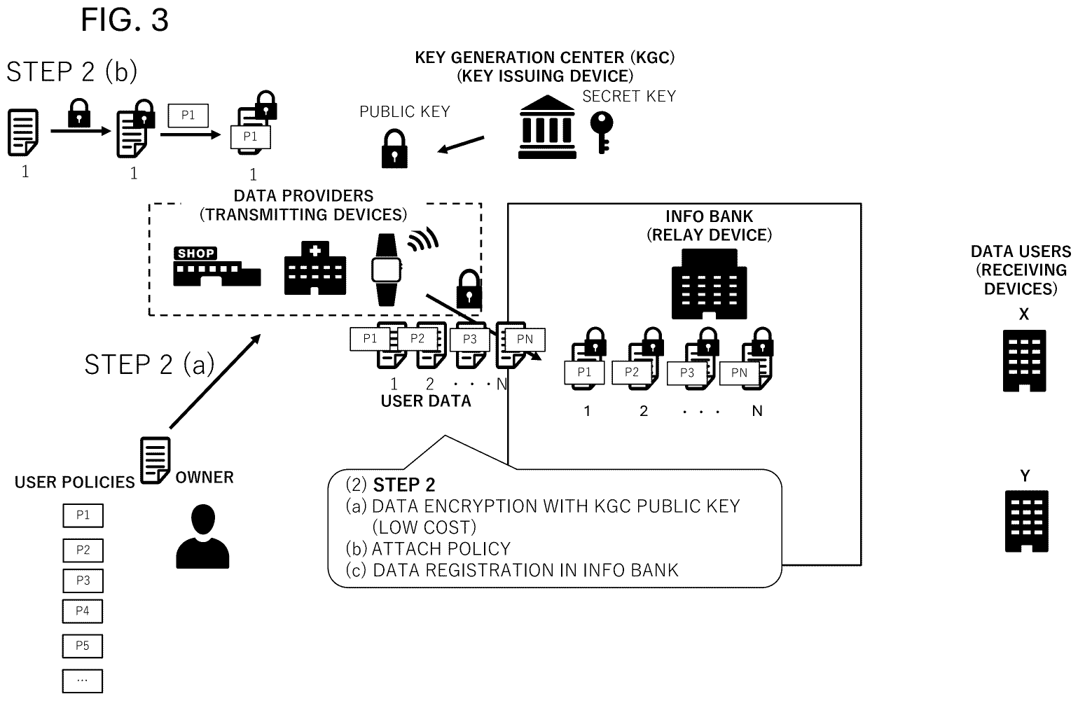

FIG. 3 illustrates a second step of a data distribution process. As described in FIG. 3, (a) the data provider (transmitting device) encrypts the data 1, 2, . . . , N with KGC public key, (b) attach each policy P1, P2, . . . , PN to the encrypted data 1, 2, . . . , N, and (c) sends the encrypted data 1, 2, . . . , N with each policy P1, P2, . . . , PN to the info bank (relay device).

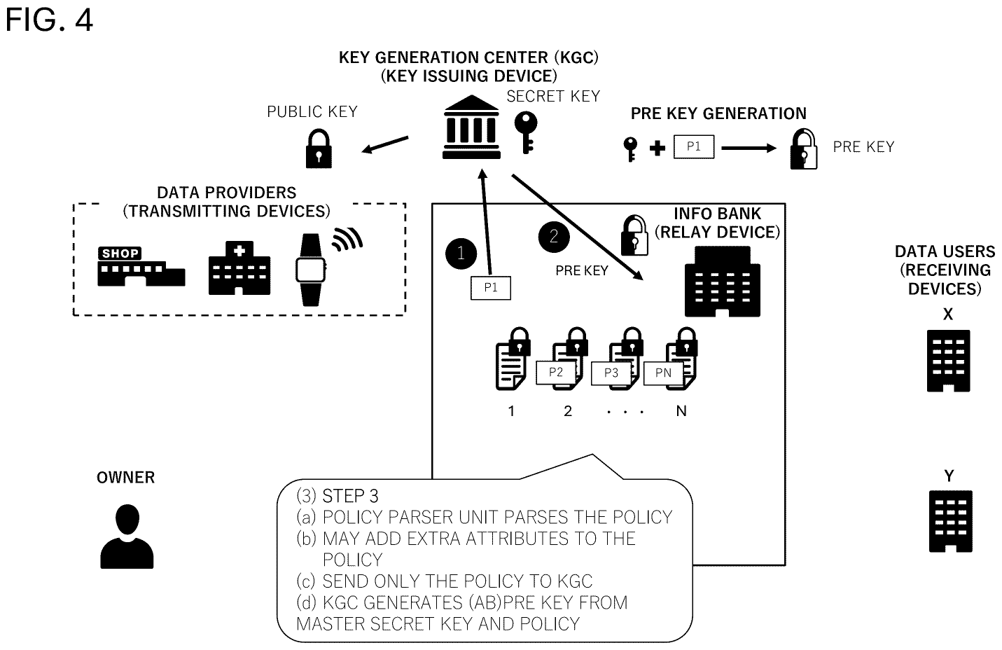

FIG. 4 illustrates a third step of a data distribution process. As described in FIG. 4, (a) the info bank (relay device) parses the policy in the encrypted data 1, 2, . . . , N, (b) may add extra attributes to the policy, (c) sends only the policy to the key generation center (KGC) (key issuing device), and (d) the key generation center (KGC) (key issuing device) generates (AB) PRE key from secret key and policy.

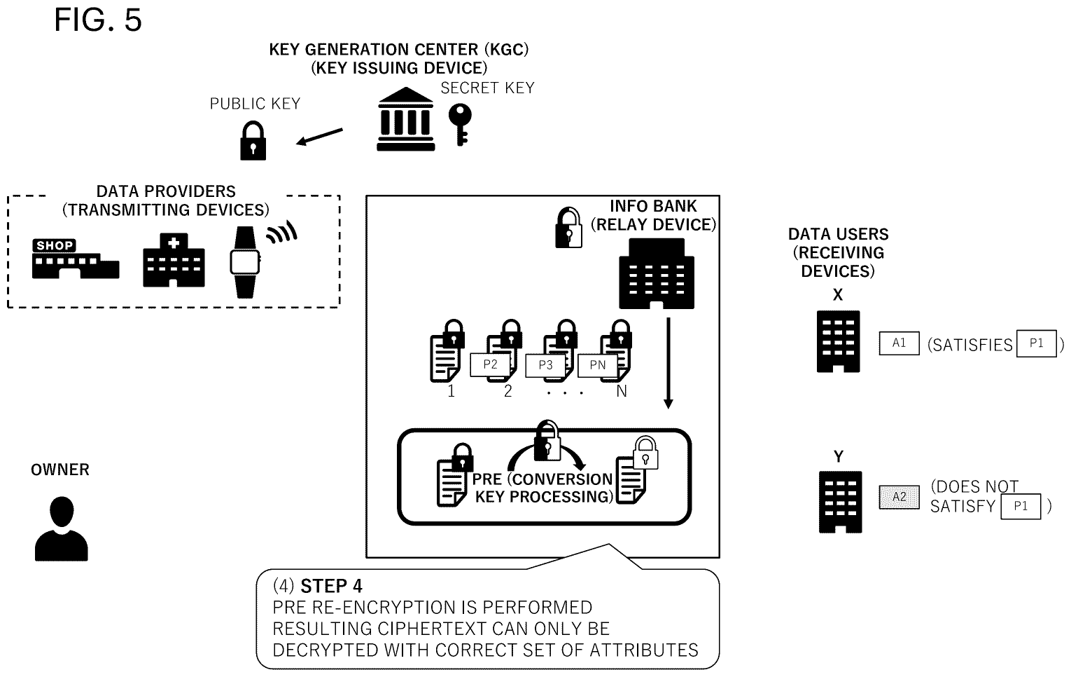

FIG. 5 illustrates a fourth step of a data distribution process. As described in FIG. 5, the info bank (relay device) re-encrypt the encrypted data 1, 2, . . . , N. The re-encrypt data can only be decrypted with correct set of attributes.

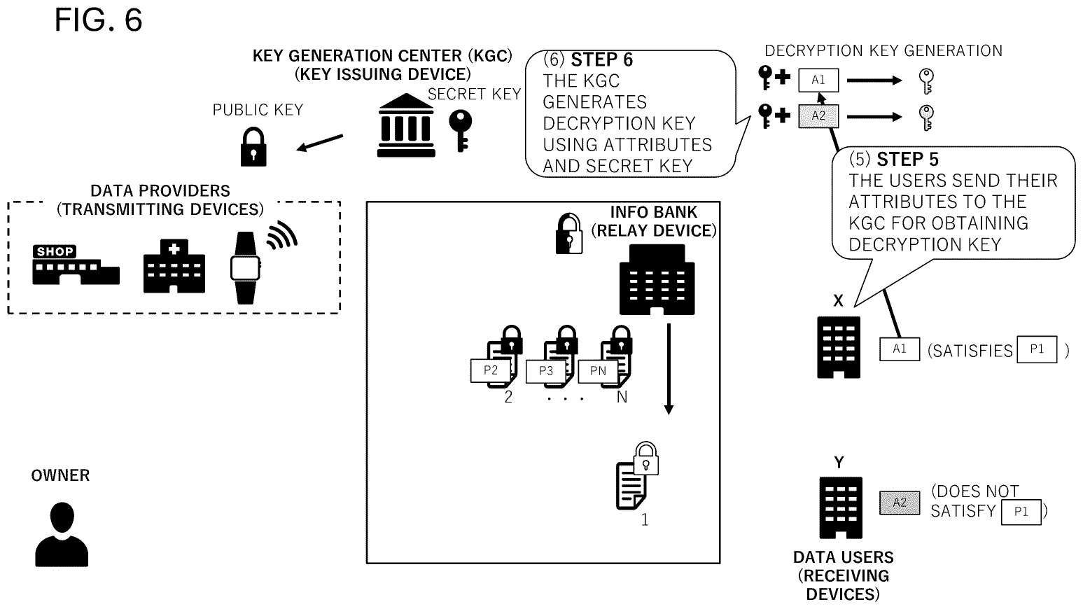

FIG. 6 illustrates a fifth and sixth step of a data distribution process. As described in FIG. 6, the data users send their attributes to the key generation center (KGC) (key issuing device) for obtaining decryption key. The key generation center (KGC) (key issuing device) generates decryption key using attributes and secret key. In this case, the attribute A1 of the data user X satisfies policy P1 but the attribute A2 of the data user Y does not satisfy policy P1. Therefore, the decryption key for the data user X is suitable to the policy P1, but the decryption key for the data user Y is not suitable to the policy P1.

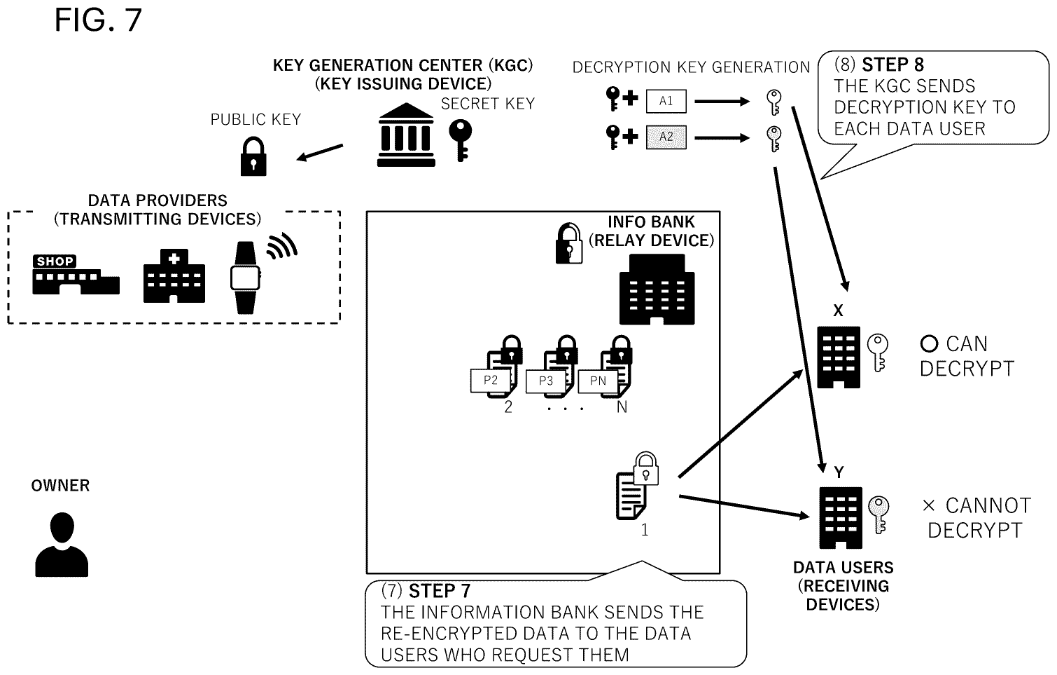

FIG. 7 illustrates a seventh and eighth step of a data distribution process. As described in FIG. 7, the info bank (relay device) sends the re-encrypted data to the data users who request them. The key generation center (KGC) (key issuing device) sends the decryption key to each data user. The data user X can decrypt the re-encrypted data because the decryption key for the data user X is suitable to the policy P1, but the data user Y cannot decrypt the re-encrypted data because the decryption key for the data user Y is not suitable to the policy P1. In this way, the above data distribution protects data so that only the data user who satisfies the policy P1 can decrypt the re-encrypted data 1.

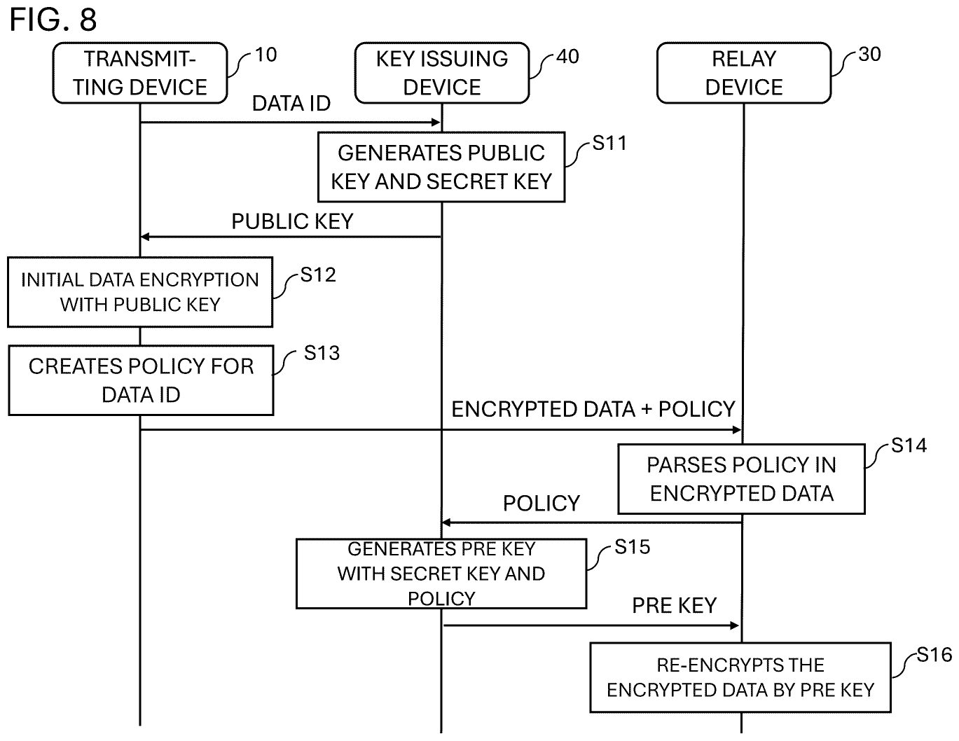

FIG. 8 is a system diagram of a data distribution method in encryption and re-encryption phase. As described in FIG. 8, the data distribution method in encryption and re-encryption phase is performed by the transmitting device 10, the key issuing device 40, and the relay device 30. The transmitting device 10 provides the data ID for the data distribution to the key issuing device 40. The key issuing device 40 generates a pair of a public key and a secret key (step S11), sends the public key to the transmitting device 10, and keeps the secret key. The transmitting device 10 encrypts initial data with public key (step S12), creates a policy for data ID (step S13), and sends the encrypted data with the policy to the relay device 30.

The relay device 30 parses the policy in the encrypted data (step 14) and provides the policy to the key issuing device 40. The key issuing device 40 generates a re-encryption key using the secret key and the policy for the data ID (step 15) and sends the re-encryption key to the relay device 30. The relay device 30 re-encrypts the encrypted data with the re-encryption key (step 16). The transmitting device 10 in the above data distribution method does not generate the re-encryption key. Therefore, the data distribution system in the above data distribution method reduces the workload in the data transmitting device 10.

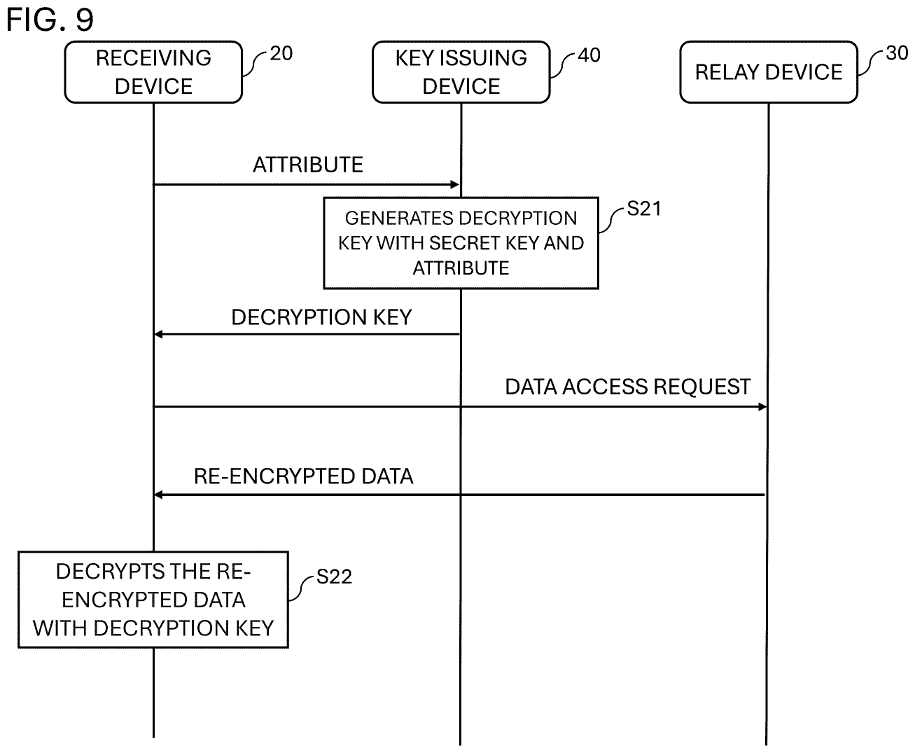

FIG. 9 is a system diagram of a data distribution method in decryption phase. As described in FIG. 9, the data distribution method in decryption phase is performed by the receiving device 20, the key issuing device 40, and the relay device 30. The receiving device 20 provides their attribute to the key issuing device 40. The key issuing device 40 generates a decryption key with the secret key and the attribute (step S21) and sends the decryption key to the receiving device 20. The receiving device 20 requests data access to the relay device 30 and the relay device 30 sends the re-encrypted data to the receiving device 20. The receiving device 20 decrypts the re-encrypted data with the decryption key (step S22). The receiving device 20 can decrypts only if the attribute of the receiving device 20 satisfies the policy for the data ID because the decryption key is generated by the attribute of the receiving device 20. In this way, the above data distribution method protects data so that only the receiving device 20 that satisfies the policy for data ID can decrypt the re-encrypted data.

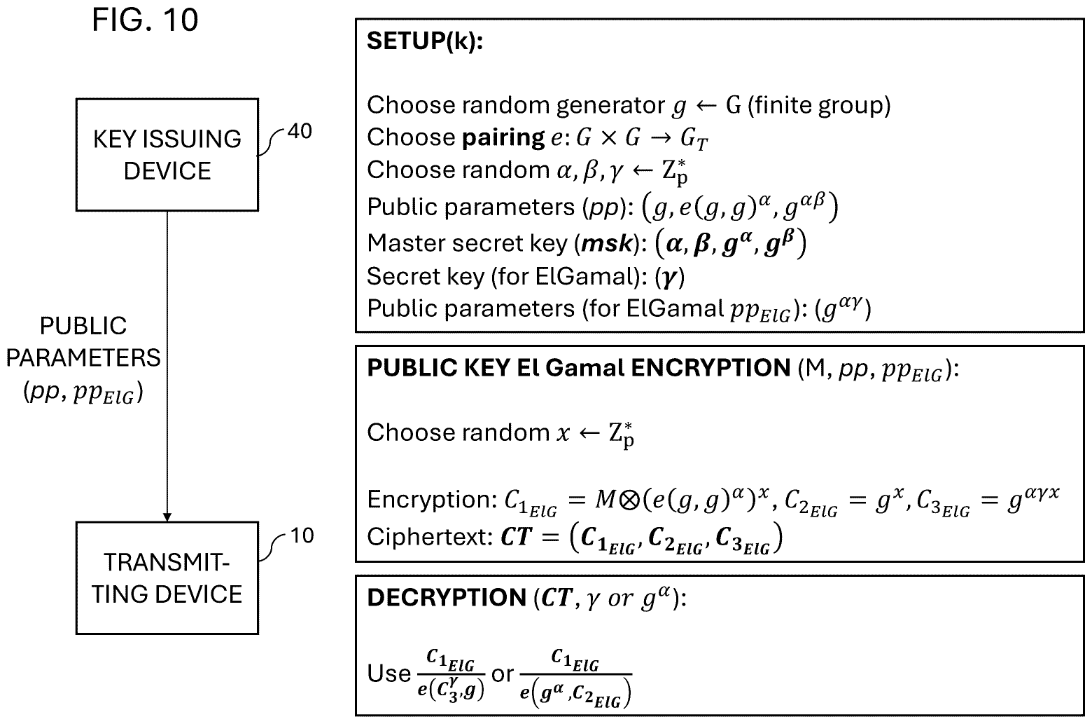

The example embodiment of the invention is explained here using an example of the process of re-encrypting ElGamal encryption data into ABE (attribute-based encryption) data. FIG. 10 illustrates a process in encryption phase. As described in FIG. 10, the key issuing device 40 performs Setup(k). Setup(k) contains processes of choosing random generator, choosing pairing and random, and also setting public parameters (pp), master secret key (msk), secret key (for ElGamal) and public parameters (for ElGamal pp_{ElG}). The key issuing device 40 sends the public parameters (pp. pp_{ElG}) to the transmitting device 10.

The transmitting device 10 receives the public parameters (pp. pp_{ElG}) and performs Public Key El Gamal Encryption for a message M with the public parameters (pp. pp_{ElG}). The transmitting device 10 chooses a random x and encrypts a message M with the public parameters (pp. pp_{ElG}). The transmitting device 10 computes ciphertext: CT=(C_{1ElG}, C_{2ElG}, C_{3ElG}).

$${C}_{{1}_{ElG}} = M ⊗ {( {e ( g , g )}^{α} )}^{x} , {C}_{{2}_{ElG}} = {g}^{x} , {C}_{{3}_{ElG}} = {g}^{αγ x} \qquad [ Math . 1 ]$$

As described above, the transmitting device 10 does not need to compute the public parameters (pp. pp_{ElG}) because the transmitting device 10 receives them from the key issuing device 40. Moreover, the transmitting device 10 encrypts the data by the public parameters raised by a secret exponent which is easily computed. This reduces the workload in a data transmitting device.

The ciphertext: CT=(C_{1ElG}, C_{2ElG}, C_{3ElG}) can be decrypted by a secret key γ or a master secret key g^{a}.

$$use \frac{{C}_{{1}_{ElG}}}{e ( {C}_{3}^{γ} , g )} or \frac{{C}_{{1}_{ElG}}}{e ( {g}^{α} , {C}_{{2}_{ElG}} )} \qquad [ Math . 2 ]$$

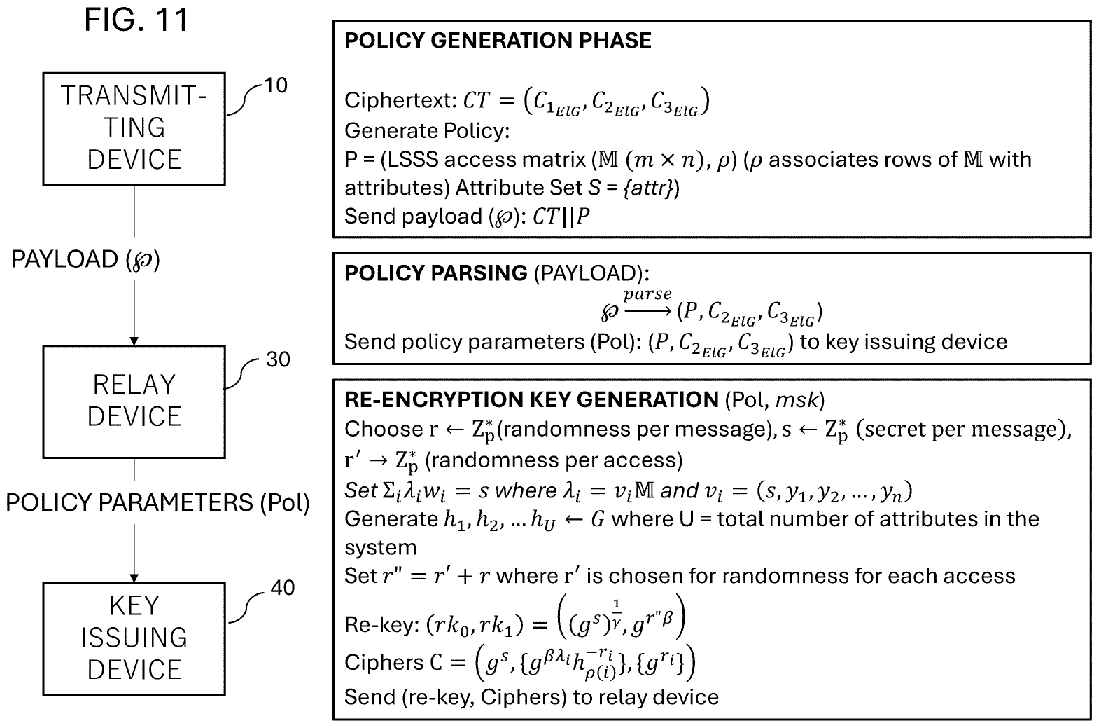

FIG. 11 illustrates a process in re-key generation phase. As described in FIG. 11, the transmitting device 10 generates policy P for the ciphertext: CT=(C_{1ElG}, C_{2ElG}, C_{3ElG}) and connects the ciphertext: CT with the policy P. The transmitting device 10 sends the payload (p): CT∥P to the relay device 30.

The relay device 30 receives the payload (p) from the transmitting device 10 and parses the payload (p) to obtain the policy parameters (Pol):(P, C_{2ElG}, C_{3ElG}). The relay device 30 sends the policy parameters (Pol) to the key issuing device 40.

The key issuing device 40 generates a re-encryption key by using the policy parameters (Pol) and the master secret key (msk). The key issuing device 40 chooses randomness r, r′ per message and secret s per message and sets Σᵢλᵢwᵢ=s where λᵢ=vᵢM and vᵢ=(s, y₁, y2, . . . , yₙ). The key issuing device 40 generates h₁, h₂, . . . , h_{U} where U is the total number of attributes in the system. The key issuing device 40 sets r″=r′+r where r′ is chosen for randomness for each access. The re-key (rk₀, rk₁) and the ciphers C are defined as follows. The key issuing device 40 sends the re-key (rk₀, rk₁) and the ciphers C=(c₁, cᵢ, dᵢ) to the relay device 30.

$$Re - key : ( {rk}_{0} , {rk}_{1} ) = ( {( {g}^{s} )}^{\frac{1}{γ}} , {g}^{{r}^{″} β} ) \\ Ciphers : C = ( {g}^{s} , \{ {g}^{{βγ}_{i}} {h}_{ρ ( i )}^{- {r}_{i}} \} , \{ {g}^{{r}_{i}} \} ) \qquad [ Math . 3 ]$$

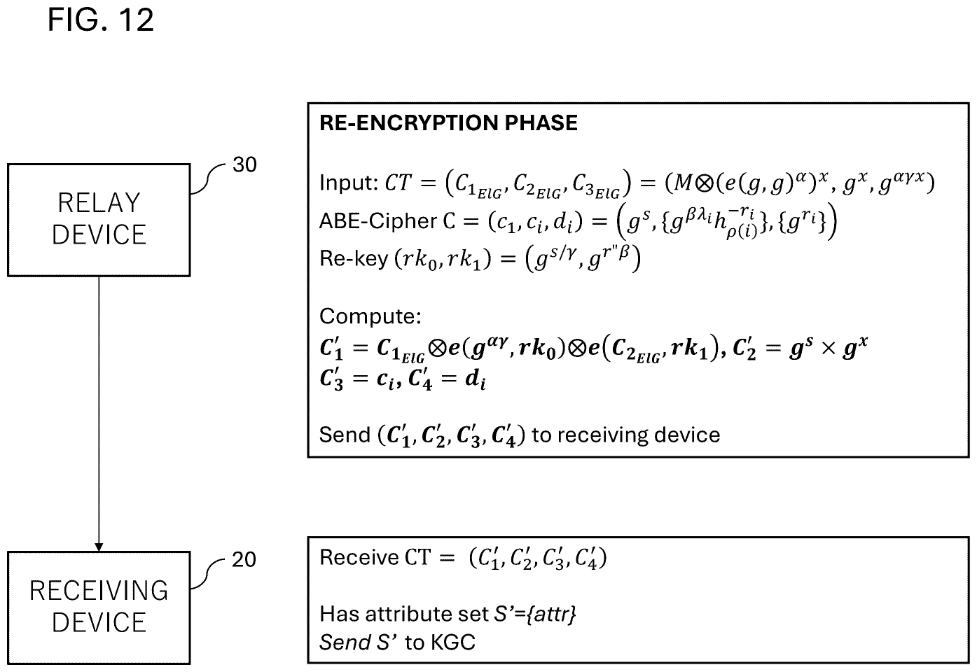

FIG. 12 illustrates a process in re-encryption phase. As described in FIG. 12, the relay device 30 re-encrypts the ciphertext: CT=(C_{1ElG}, C_{2ElG}, C_{3ElG}) by using ABE-Ciphers C=(c₁, cᵢ, dᵢ) and the re-key (rk₀, rk₁). The relay device 30 computes the re-encrypted ciphertext (C′₁, C′₂, C′₃, C′₄) as follows, and sends the re-encrypted ciphertext (C′₁, C′₂, C′₃, C′₄) to the receiving device 20.

$${C}_{1}^{′} = {C}_{{1}_{ElG}} ⊗ e ( {g}^{αγ} , {rk}_{0} ) ⊗ e ( {C}_{{2}_{ElG}} , {rk}_{1} ) , {C}_{2}^{′} = {g}^{s} \times {g}^{x} , {C}_{3}^{′} = {c}_{i} , {C}_{4}^{′} = {d}_{i} \qquad [ Math . 4 ]$$

The receiving device 20 receives the re-encrypted ciphertext (C′₁, C′₂, C′₃, C′₄) and sends attribute set S′={attr} to the key issuing device 40 where the receiving device 20 has attribute set S′={attr}.

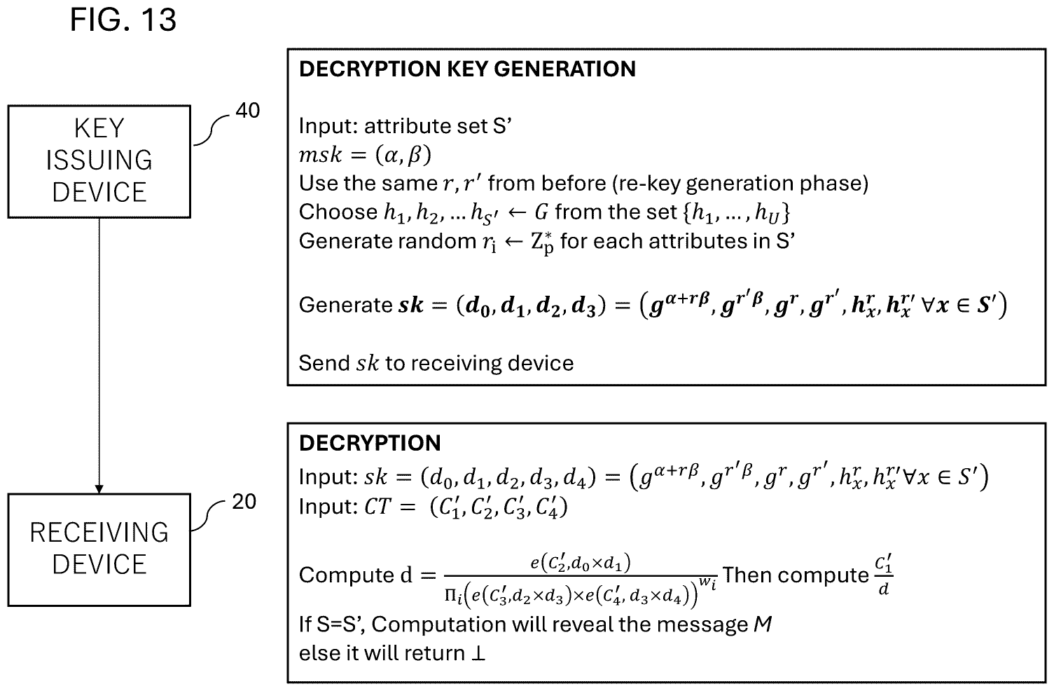

FIG. 13 illustrates a process in decryption phase. As described in FIG. 13, the key issuing device 40 generates a decryption key from the attribute set S′. The key issuing device 40 uses the master secret key (msk) and the randomness r, r′ same in the re-key generation phase. The key issuing device 40 generates random rᵢ for each attribute in S′. The key issuing device 40 generates the decryption key sk=(d₀, d₁, d₂, d₃) as follows and sends the decryption key sk to the receiving device 20.

$$sk = ( {d}_{0} , {d}_{1} , {d}_{2} , {d}_{3} ) = ( {g}^{α + r β} , {g}^{{r}^{′} β} , {g}^{r} , {g}^{{r}^{′}} , {h}_{x}^{r} , {h}_{x}^{r ′} ∀ x ∈ {S}^{′} ) \qquad [ Math . 5 ]$$

The receiving device 20 decrypts the re-encrypted ciphertext (C′₁, C′₂, C′₃, C′₄) by using the decryption key sk=(d₀, d₁, d₂, d₃). The receiving device 20 computes d as follows and then computes C′₁/d. If S=S′, the computation will reveal the message M, else it will return false T.

$$d = \frac{e ( {C}_{2}^{′} , {d}_{0} \times {d}_{1} )}{{{Π}_{i} ( e ( {C}_{3}^{′} , {d}_{2} \times {d}_{3} ) \times e ( {C}_{4}^{′} , {d}_{3} \times {d}_{4} ) )}^{{w}_{i}}} \qquad [ Math . 6 ]$$

The correctness of the above re-encryption can be verified by the following calculations.

$$First let ' s compute {{Π}_{i} ( e ( {C}_{3}^{′} , {g}^{r} \times {g}^{r ′} ) \times e ( {C}_{4}^{′} , {h}_{x}^{r} \times {h}_{x}^{r ′} ) )}^{{w}_{i}} assuming = {S}^{′} = Se ( {C}_{3}^{′} , {g}^{r} \times {g}^{r ′} ) \times e ( {C}_{4}^{′} , {h}_{x}^{r} \times {h}_{x}^{r ′} ) = e ( {g}^{{βλ}_{i}} {h}_{ρ ( i )}^{- {r}_{i}} , {g}^{{r}^{″}} ) \times e ( {g}^{{r}_{i}} , {h}_{ρ ( i )}^{{r}^{″}} ) = {e ( g , g )}^{β {r}^{″} {λ}_{i}} {{Π}_{i} ( e ( {C}_{3}^{′} , {g}^{{r}^{″}} ) \times e ( {C}_{4}^{′} , {h}_{x}^{{r}^{″}} ) )}^{{w}_{i}} = {Π}_{i} {e ( g , g )}^{β {r}^{″} {λ}_{i} {w}_{i}} = {e ( g , g )}^{β {r}^{″} {Σ}_{i} {λ}_{i} {w}_{i}} = {e ( g , g )}^{β {r}^{″} s} if ( {S}^{′} = S ) otherwise ⊥ \\ Now let ' s compute e ( {C}_{2}^{′} , {d}_{0} \times {d}_{2} ) = e ( {g}^{s} \times {g}^{x} , {g}^{α + r β} \times {g}^{{r}^{′} β} ) = {e ( g , g )}^{( s + x ) ( α + ( r + {r}^{′} ) β )} = {e ( g , g )}^{( s + x ) ( α + {r}^{″} β )} \\ Therefore d = \frac{e ( {C}_{2}^{′} , {d}_{0} \times {d}_{2} )}{{{Π}_{i} ( e ( {C}_{3}^{′} , {d}_{1} \times {d}_{2} ) \times e ( {C}_{4}^{′} , {d}_{3} \times {d}_{4} ) )}^{{w}_{i}}} = \frac{{e ( g , g )}^{( s + x ) ( α + {r}^{″} β )}}{{e ( g , g )}^{β {r}^{″} s}} = {e ( g , g )}^{α s + α x + {r}^{″} β x} \\ Now , finally we compute {C}_{1}^{′} = {C}_{1} \times e ( {rk}_{0} , {pp}_{ElG} ) \times e ( {rk}_{1} , {C}_{{2}_{ElG}} ) = M \times {e ( g , g )}^{α x} \times e ( {g}^{s / γ} , {g}^{αγ} ) ⅇ ( {g}^{{r}^{″} β} , {g}^{x} ) = M \times {e ( g , g )}^{α x + α s + {r}^{″} β x} = M \times d \qquad [ Math . 7 ]$$

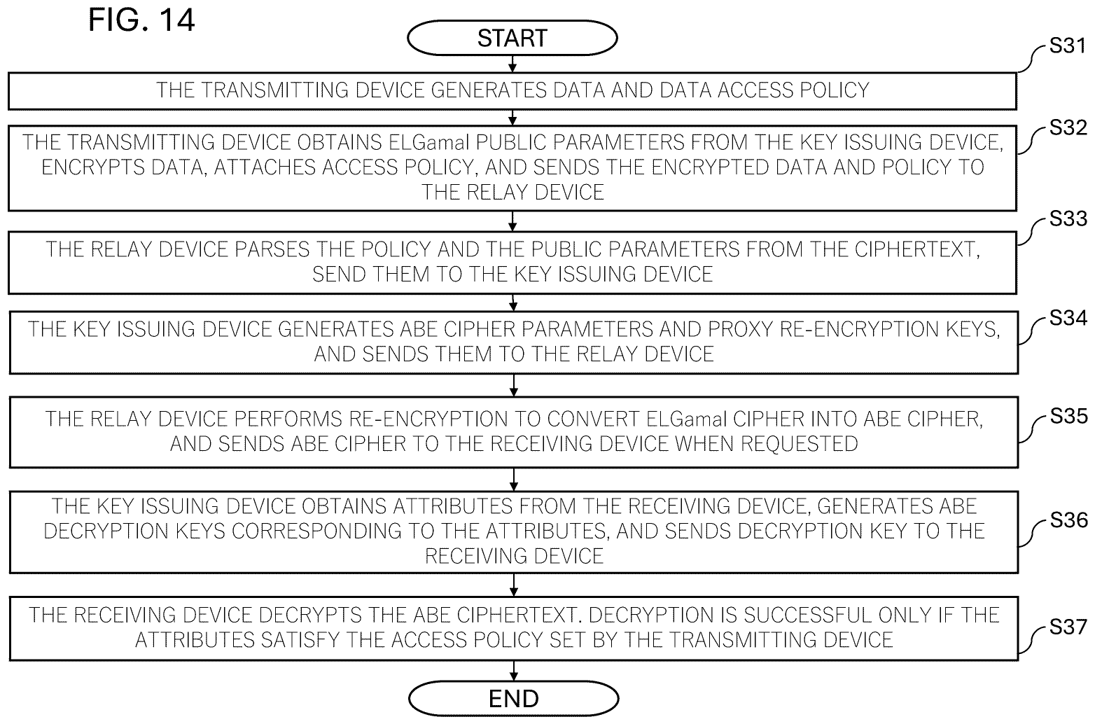

FIG. 14 is a flow chart of a data distribution method. As described in FIG. 14, the transmitting device 10 generates data and data access policy (Step 31). The transmitting device 10 obtains ElGamal public parameters from the key issuing device 40, encrypts data, attaches access policy, and sends the encrypted data and policy to the relay device 30 (Step 32). The relay device 30 parses the policy and the public parameters from the ciphertext, send them to the key issuing device 40 (Step 33). The key issuing device 40 generates ABE (attribute-based encryption) cipher parameters and proxy re-encryption keys, and sends them to the relay device 30 (Step 34). The relay device 30 performs re-encryption to convert ElGamal cipher into ABE cipher, and sends ABE cipher to the receiving device 20 when requested (Step 35). The key issuing device 40 obtains attributes from the receiving device 20, generates ABE decryption keys corresponding to the attributes, and sends decryption key to the receiving device 20 (Step 36). The receiving device 20 decrypts the ABE ciphertext. Decryption is successful only if the attributes satisfy the access policy set by the transmitting device 10 (Step 37).

### [Hardware Configuration]

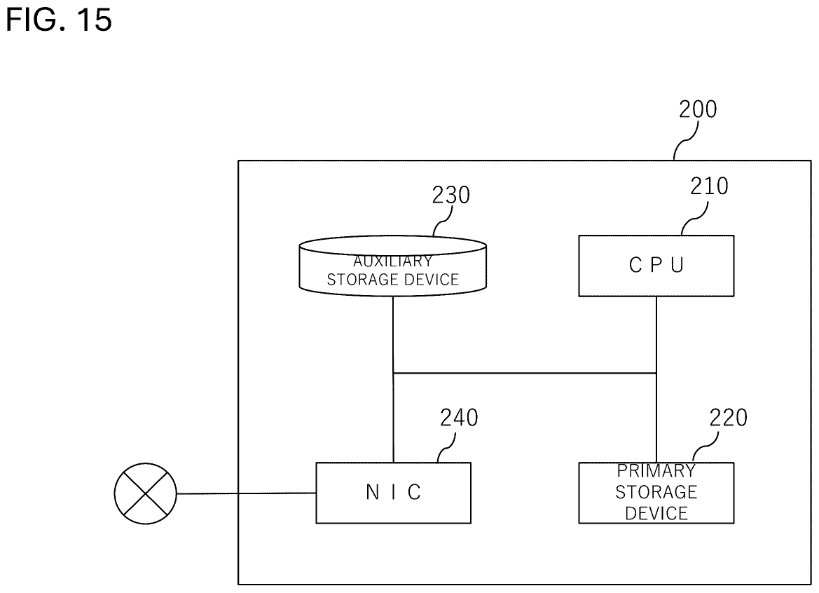

FIG. 15 is a drawing illustrating an example of a hardware configuration of the transmitting device, the receiving device, the relay device and the key issuing device. The transmitting device 10, the receiving device 20, the relay device 30 and the key issuing device 40 described above may be configured as an information processing apparatus (computer) 200 having the hardware configuration shown in FIG. 15. It should be noted that the hardware configuration shown in FIG. 15 is merely an example of the hardware configuration realizing the function of the transmitting device 10, the receiving device 20, the relay device 30 and the key issuing device 40 and is not intended to limit the hardware configuration of the transmitting device 10, the receiving device 20, the relay device 30 and the key issuing device 40. The transmitting device 10, the receiving device 20, the relay device 30 and the key issuing device 40 may include hardware not shown in FIG. 14.

As shown in FIG. 15, the computer 200 comprises a CPU (Central Processing Unit) 210, a primary storage device 220, an auxiliary storage device 230, and a NIC (Network Interface Card) 240, which is a communication interface. These elements are connected to each other by, for instance, an internal bus.

The CPU 210 executes the access control program. The primary storage device 220 is, for instance, a RAM (Random Access Memory) and temporarily stores the access control program executed by the computer 200 so that the CPU 210 can process it.

The auxiliary storage device 230 is, for instance, an HDD (Hard Disk Drive) and may store the data distribution program in the medium to long term. The access control program may be provided as a computer program stored in a non-transitory computer-readable storage medium. The auxiliary storage device 230 can be used to store the access control program stored in a non-transitory computer-readable storage medium over the medium to long term.

The NIC 240 provides an interface to an external terminal via a network. The NIC 240 is used to receive or to transmit traffic communications.

When the computer 200 as described above executes the data distribution program, the computer 200 acts as the transmitting device 10, the receiving device 20, the relay device 30 and the key issuing device 40 and implements the data distribution method shown in FIG. 8, 9.

The above example embodiments may partially or entirely be described, but not limited to, as the following notes.

### (Note 1)

A data distribution system that distributes an encrypted data from a transmitting device to a receiving device via a relay device with support by a key issuing device, wherein
the key issuing device is configured to generate public parameters for ElGamal encryption and a secret key for attribute-based encryption, send the public parameters to the transmitting device and keep the secret key;
the transmitting device is configured to encrypt data by the public parameters, create a user defined policy for each data ID, attach the defined policy for the corresponding data ID to the encrypted data and send the encrypted data with the user defined policy to the relay device; the relay device is configured to separate the user defined policy from the encrypted data and provide the user defined policy to the key issuing device;
the key issuing device is configured to generate a re-encryption key with a cipher by using the secret key and the user defined policy for the corresponding data ID and a decryption key to decrypt the re-encrypted data by the receiving device that satisfies the user defined policy, send the re-encryption key with the cipher to the relay device and send the decryption key to the receiving device that satisfies the user defined policy;
the relay device is configured to re-encrypt the encrypted data of data ID by using the re-encryption key with the cipher and send the re-encrypted data to the receiving device; and
the receiving device is configured to decrypt the re-encrypted data by using the decryption key.

### (Note 2)

The data distribution system according to Note 1, wherein
the transmitting device encrypts the data by the public parameters raised by a secret exponent.

### (Note 3)

The data distribution system according to Note 1 or 2, wherein
the re-encryption key has 2 components wherein first component contains a first secret from ElGamal encryption, and second component contains a second secret from attribute-based encryption.

### (Note 4)

The data distribution system according to any one of Notes 1-3, wherein
the key issuing device uses types of randomness, wherein first randomness is used for each message to be encrypted, and second randomness is used for each access request for that message from the receiving device.

### (Note 5)

A data distribution method to distribute an encrypted data from a transmitting device to a receiving device via a relay device with support by a key issuing device, the method comprising:
generating, by the key issuing device, public parameters for ElGamal encryption and a secret key for attribute-based encryption, sending the public key to the transmitting device and keeping the secret key;
encrypting, by the transmitting device, data by the public parameters, creates a user defined policy for each data ID, attaching the user defined policy for the corresponding data ID to the encrypted data and sending the encrypted data with the user defined policy to the relay device;
separating, by the relay device, the user defined policy from the encrypted data and providing the user defined policy to the key issuing device;
generating, by the key issuing device, a re-encryption key with a cipher by using the secret key and the user defined policy for the corresponding data ID and a decryption key to decrypt the re-encrypted data by the receiving device that satisfies the user defined policy, sending the re-encryption key with the cipher to the relay device and sending the decryption key to the receiving device that satisfies the user defined policy;
re-encrypting, by the relay device, the encrypted data of data ID by using the re-encryption key with the cipher and sends the re-encrypted data to the receiving device; and
decrypting, by the receiving device, the re-encrypted data by using the decryption key.

### (Note 6)

The data distribution method according to Note 5, wherein
the transmitting device encrypts the data by the public parameters raised by a secret exponent.

### (Note 7)

The data distribution method according to Note 5 or 6, wherein
the re-encryption key has 2 components wherein first component contains a first secret from ElGamal encryption, and second component contains a second secret from attribute-based encryption.

### (Note 8)

The data distribution method according to any one of Notes 5-7, wherein
the key issuing device uses types of randomness, wherein first randomness is used for each message to be encrypted, and second randomness is used for each access request for that message from the receiving device.

### (Note 9)

A data distribution program to distribute an encrypted data from a transmitting device to a receiving device via a relay device with support by a key issuing device, including:
causing the key issuing device to generate public parameters for ElGamal encryption and a secret key for attribute-based encryption, send the public parameters to the transmitting device and keep the secret key;
causing the transmitting device to encrypt data by the public parameters, create a user defined policy for each data ID, attach the defined policy for the corresponding data ID to the encrypted data and send the encrypted data with the user defined policy to the relay device;
causing the relay device to separate the user defined policy from the encrypted data and provide the user defined policy to the key issuing device;
causing the key issuing device to generate a re-encryption key with a cipher by using the secret key and the user defined policy for the corresponding data ID and a decryption key to decrypt the re-encrypted data by the receiving device that satisfies the user defined policy, send the re-encryption key with the cipher to the relay device and send the decryption key to the receiving device that satisfies the user defined policy;
causing the relay device to re-encrypt the encrypted data of data ID by using the re-encryption key with the cipher and send the re-encrypted data to the receiving device; and
causing the receiving device to decrypt the re-encrypted data by using the decryption key.

### (Note 10)

The data distribution program according to Note 9, wherein
the transmitting device encrypts the data by the public parameters raised by a secret exponent.

### (Note 11)

The data distribution program according to Note 9 or 10, wherein
the re-encryption key has 2 components wherein first component contains a first secret from ElGamal encryption, and second component contains a second secret from attribute-based encryption.

### (Note 12)

The data distribution program according to any one of Notes 9-11, wherein
the key issuing device uses types of randomness, wherein first randomness is used for each message to be encrypted, and second randomness is used for each access request for that message from the receiving device.

While each example embodiment of the present invention has been described, it is to be noted that it is possible to modify or adjust the example embodiments or examples within the whole disclosure of the present invention (including the Claims) and based on the basic technical concept thereof. Further, it is possible to variously combine or select (or at least partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without explicit recital thereof. Further, the disclosure of Patent Literature cited above is incorporated herein in its entirety by reference thereto.

### REFERENCE SIGNS LIST

100 data distribution system
10 transmitting device
20 receiving device
30 relay device
40 key issuing device
200 information processing apparatus (computer)
210 CPU (Central Processing Unit)
220 primary storage device
230 auxiliary storage device
240 NIC (Network Interface Card)

What is claimed is:

1. A data distribution system that distributes an encrypted data from a transmitting device to a receiving device via a relay device with support by a key issuing device, wherein
the key issuing device is configured to generate public parameters for ElGamal encryption and a secret key for attribute-based encryption, send the public parameters to the transmitting device and keep the secret key;
the transmitting device is configured to encrypt data by the public parameters, create a user defined policy for each data ID, attach the defined policy for the corresponding data ID to the encrypted data and send the encrypted data with the user defined policy to the relay device;
the relay device is configured to separate the user defined policy from the encrypted data and provide the user defined policy to the key issuing device;
the key issuing device is configured to generate a re-encryption key with a cipher by using the secret key and the user defined policy for the corresponding data ID and a decryption key to decrypt the re-encrypted data by the receiving device that satisfies the user defined policy, send the re-encryption key with the cipher to the relay device and send the decryption key to the receiving device that satisfies the user defined policy;
the relay device is configured to re-encrypt the encrypted data of data ID by using the re-encryption key with the cipher and send the re-encrypted data to the receiving device; and
the receiving device is configured to decrypt the re-encrypted data by using the decryption key.

2. The data distribution system according to claim 1, wherein
the transmitting device encrypts the data by the public parameters raised by a secret exponent.

3. The data distribution system according to claim 1, wherein
the re-encryption key has 2 components wherein first component contains a first secret from ElGamal encryption, and second component contains a second secret from attribute-based encryption.

4. The data distribution system according to claim 1, wherein
the key issuing device uses types of randomness, wherein first randomness is used for each message to be encrypted, and second randomness is used for each access request for that message from the receiving device.

5. A data distribution method to distribute an encrypted data from a transmitting device to a receiving device via a relay device with support by a key issuing device, the method comprising:
generating, by the key issuing device, public parameters for ElGamal encryption and a secret key for attribute-based encryption, sending the public key to the transmitting device and keeping the secret key;
encrypting, by the transmitting device, data by the public parameters, creates a user defined policy for each data ID, attaching the user defined policy for the corresponding data ID to the encrypted data and sending the encrypted data with the user defined policy to the relay device;
separating, by the relay device, the user defined policy from the encrypted data and providing the user defined policy to the key issuing device;
generating, by the key issuing device, a re-encryption key with a cipher by using the secret key and the user defined policy for the corresponding data ID and a decryption key to decrypt the re-encrypted data by the receiving device that satisfies the user defined policy, sending the re-encryption key with the cipher to the relay device and sending the decryption key to the receiving device that satisfies the user defined policy;
re-encrypting, by the relay device, the encrypted data of data ID by using the re-encryption key with the cipher and sends the re-encrypted data to the receiving device; and
decrypting, by the receiving device, the re-encrypted data by using the decryption key.

6. The data distribution method according to claim 5, wherein
the transmitting device encrypts the data by the public parameters raised by a secret exponent.

7. The data distribution method according to claim 5, wherein
the re-encryption key has 2 components wherein first component contains a first secret from ElGamal encryption, and second component contains a second secret from attribute-based encryption.

8. The data distribution method according to claim 5, wherein
the key issuing device uses types of randomness, wherein first randomness is used for each message to be encrypted, and second randomness is used for each access request for that message from the receiving device.

9. A non-transitory computer readable medium storing a data distribution program to distribute an encrypted data from a transmitting device to a receiving device via a relay device with support by a key issuing device, the program:
causing the key issuing device to generate public parameters for ElGamal encryption and a secret key for attribute-based encryption, send the public parameters to the transmitting device and keep the secret key;
causing the transmitting device to encrypt data by the public parameters, create a user defined policy for each data ID, attach the defined policy for the corresponding data ID to the encrypted data and send the encrypted data with the user defined policy to the relay device;
causing the relay device to separate the user defined policy from the encrypted data and provide the user defined policy to the key issuing device;
causing the key issuing device to generate a re-encryption key with a cipher by using the secret key and the user defined policy for the corresponding data ID and a decryption key to decrypt the re-encrypted data by the receiving device that satisfies the user defined policy, send the re-encryption key with the cipher to the relay device and send the decryption key to the receiving device that satisfies the user defined policy;
causing the relay device to re-encrypt the encrypted data of data ID by using the re-encryption key with the cipher and send the re-encrypted data to the receiving device; and
causing the receiving device to decrypt the re-encrypted data by using the decryption key.

10. The non-transitory computer readable medium storing the data distribution program according to claim 9, wherein
the transmitting device encrypts the data by the public parameters raised by a secret exponent.

11. The non-transitory computer readable medium storing the data distribution program according to claim 9, wherein
the re-encryption key has 2 components wherein first component contains a first secret from ElGamal encryption, and second component contains a second secret from attribute-based encryption.

12. The non-transitory computer readable medium storing the data distribution program according to claim 9, wherein
the key issuing device uses types of randomness, wherein first randomness is used for each message to be encrypted, and second randomness is used for each access request for that message from the receiving device.
